(19) United States
(12) Patent Application Publication
(10) Pub. No.: US 2013/0252728 A1
(43) Pub. Date: Sep. 26, 2013

(54) GAME APPARATUS, PROGRAM, AND GAME PROVIDING METHOD

(71) Applicants: Sadaaki Kaneyoshi, Tokyo (JP); Shohei Tada, Tokyo (JP); Takanori Mitsui, Tokyo (JP)

(72) Inventors: Sadaaki Kaneyoshi, Tokyo (JP); Shohei Tada, Tokyo (JP); Takanori Mitsui, Tokyo (JP)

(73) Assignee: KONAMI DIGITAL ENTERTAINMENT CO., LTD., Tokyo (JP)

(21) Appl. No.: 13/992,054

(22) PCT Filed: Apr. 19, 2012
(86) PCT No.: PCT/JP2012/060602

§ 371 Date: Jun. 6, 2013

(30) Foreign Application Priority Data
Jun. 30, 2011 (JP) 2011-146367

(51) Int. Cl. A63F 13/00

(52) U.S. Cl. CPC A63F 13/00
USPC 463/29

(57) ABSTRACT

A storage unit stores identification information of each player of a game and a registration code specified for the player in association with each other. A controller acquires a verification code from a terminal apparatus of an invitee who is invited to the game by a player of the game who serves as an inviter, searches the storage unit for a registration code that matches the verification code, and grants a privilege related to the game to an inviter indicated by the identification information stored in the storage section in association with the registration code searched for.

### TECHNICAL FIELD

The present invention relates to technologies for allowing a player of a game to invite other people to the game (that is, to propose playing the game to other people).

### BACKGROUND ART

On-line games, such as social games, provided to a terminal apparatus of each player through communication with a server apparatus via a communication network, such as the Internet, have become wide-spread (see Non-Patent Document 1, for example). When each player starts the game on his or her terminal apparatus, unique identification information is assigned to the player, and information related to the progress of the player in the game is associated with the identification information and is managed.

### CITATION LIST

### Non-Patent Document

Non-Patent Document 1: Application Style Vol. 2, a social game information magazine, published by East Press Co. Ltd., Apr. 1, 2011, pp. 26-29 (written in Japanese)

### SUMMARY OF INVENTION

### Technical Problem

It is possible to make games even more wide-spread if a player who has played a game is allowed to invite another person (hereafter called an invitee) to the game. To encourage a player to actively invite another person to the game, it is necessary to grant, for example, a privilege in the game to the player serving as an inviter when an invitee accepts the invitation and actually starts the game. Therefore, a mechanism is required to understand the relationship between the inviter and the invitee. However, since the invitee has not played the game before and therefore is not assigned any identification information for identifying the invitee, it is difficult to associate the inviter and the invitee when the inviter invites the invitee to the game. Taking this situation into consideration, an object of the present invention is to allow a player who has played a game to invite another person to the game and to grant a privilege to the player.

### Solution to Problem

A game apparatus according to the present invention provides a game while communicating with individual terminal apparatuses. The game apparatus includes a verification-code acquisition section that acquires a verification code from a terminal apparatus of an invitee who is invited to the game by a player of the game who serves as an inviter; a code verification section that searches a storage section that stores identification information of each player of the game and a registration code specified for the player in association with each other, for a registration code that matches the verification code acquired by the verification-code acquisition section; and a privilege granting section that grants a privilege related to the game to an inviter indicated by the identification information stored in the storage section in association with the registration code searched for by the code verification section.

In the present invention, the game apparatus may directly communicate with the individual terminal apparatuses, or may indirectly communicate with the individual terminal apparatuses via a relay apparatus. A game apparatus for providing a game while communicating with individual terminal apparatuses, according to the present invention, certainly includes, for example, a game apparatus for providing a game while communicating with individual terminal apparatuses via a server apparatus, to be described later.

In the present invention, it is preferable that the storage section store a registration code specified by an inviter and identification information of the inviter in association with each other. It is preferable that the game apparatus further include a registration-code acquisition section that acquires the registration code specified by the inviter from the terminal apparatus of the inviter, and the storage unit associate the registration code acquired by the registration-code acquisition section with the identification information of the inviter and store them. The terminal apparatus of the invitee and the terminal apparatus of the inviter are differentiated in wording for the sake of formality. In the present invention, the inviter and the invitee may use different terminal apparatuses, or may share one terminal apparatus.

In the present invention, it is preferable that the game apparatus further include a selection accepting section that acquires selection information that specifies an invitee selected by the inviter, and a code notification section that notifies the invitee specified by the selection information acquired by the selection accepting section, of the registration code specified by the inviter. In a configuration in which the game apparatus communicates with a server apparatus that provides the terminal apparatus of a member with a message sent to the member, for example, the code notification section instructs the server apparatus to provide a member indicated by selection information determined by the inviter with a message that includes the registration code specified by the inviter, stored in the storage section.

In the present invention, it is preferable that the game apparatus further include a relationship acquisition section that acquires member relationship information that specifies a member for whom a relationship with the inviter has been registered, and a candidate providing section that provides a terminal apparatus of the inviter with the member specified by the member relationship information acquired by the relationship acquisition section as an invitee candidate, and the selection information specify a member selected by the inviter from the member provided by the candidate providing section.

In the present invention, it is preferable that the member relationship information indicate, for each member specified by the member relationship information, whether the member has played the game, and the candidate providing section provide the terminal apparatus of the inviter with information indicating whether the member has played the game, for each member specified by the member relationship information.

In the present invention, it is preferable that the member relationship information indicate, for each member specified by the member relationship information, whether the member has played the game, and the candidate providing section provide the terminal apparatus of the inviter with a member who has not yet played the game from a member specified by the member relationship information.

In the present invention, it is preferable that the game apparatus further include an inviter inquiry section that provides the terminal apparatus of the invitee with the inviter indicated by the identification information stored in the storage section in association with the registration code searched for by the code verification section and asks the invitee whether the inviter is correct, and, when the result of the inquiry made by the inviter inquiry section is affirmative, the privilege granting section grant the privilege to the inviter.

The present invention can also be applied to a program for causing a computer to function as the game apparatus described above. A program of the present invention causes a computer that provides a game while communicating with individual terminal apparatuses to function as a verification-code acquisition section that acquires a verification code from a terminal apparatus of an invitee who is invited to the game by a player of the game who serves as an inviter; a code verification section that searches a storage section that stores identification information of each player of the game and a registration code specified for the player in association with each other, for a registration code that matches the verification code acquired by the verification-code acquisition section; and a privilege granting section that grants a privilege related to the game to an inviter indicated by the identification information stored in the storage section in association with the registration code searched for by the code verification section. A program of the present invention is stored in a computer-readable recording medium, is provided in that form, and is installed in a computer. Alternatively, the program of the present invention is distributed through a communication network and is installed in a computer.

The present invention can also be applied to a game providing method. A game providing method of the present invention provides a game while communicating with individual terminal apparatuses. The game providing method includes acquiring a verification code from a terminal apparatus of an invitee who is invited to the game by a player of the game who serves as an inviter; searching a storage section that stores identification information of each player of the game and a registration code specified for the player in association with each other, for a registration code that matches the acquired verification code; and granting a privilege related to the game to an inviter indicated by the identification information stored in the storage section in association with the registration code searched for.

### BRIEF DESCRIPTION OF DRAWINGS

FIG. 1 is a block diagram of a communication system according to a first embodiment of the present invention.

FIG. 2 is a typical view of member information stored for each member in an SNS server apparatus.

FIG. 3 is a typical view of player information stored for each player in a game apparatus.

FIG. 4A is a flowchart of a procedure in which a registration code is registered.

FIG. 4B is a flowchart of a procedure in which the registration code is sent to an invitee.

FIG. 4C is a flowchart of a procedure in which the invitee sends the registration code to the game apparatus.

FIG. 5 is a typical view of member information in a second embodiment.

FIG. 6A and FIG. 6B form a flowchart of a procedure in the second embodiment.

FIG. 7 is a typical view of an invitee candidate list in the second embodiment.

FIG. 8 is a typical view of an invitee candidate list in a third embodiment.

FIG. 9 is a flowchart of a procedure in a fourth embodiment.

### DESCRIPTION OF EMBODIMENTS

### First Embodiment

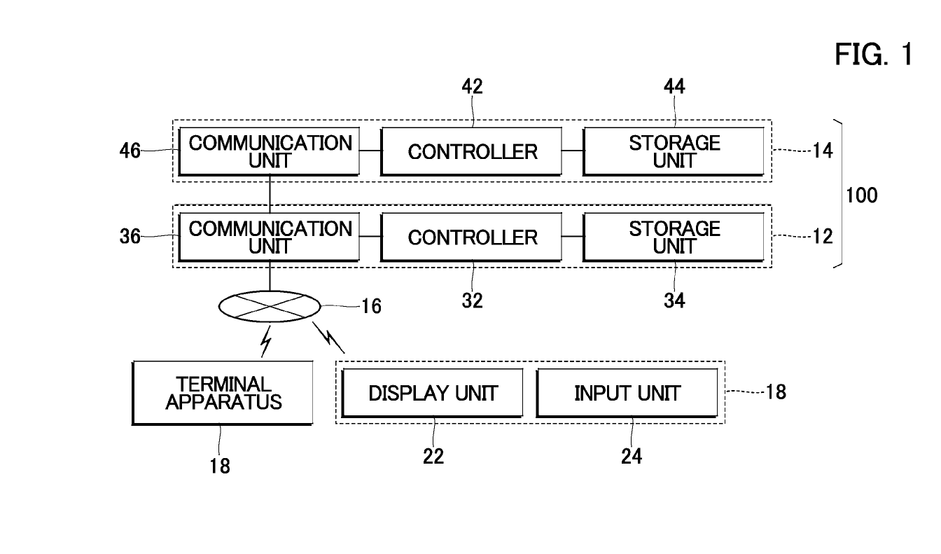

FIG. 1 is a block diagram of a communication system 100 according to a first embodiment of the present invention. The communication system 100 of the first embodiment is a computer system for providing registered members with a social network service (SNS) and includes an SNS server apparatus 12 and a game apparatus 14. The SNS server apparatus 12 communicates with the terminal apparatus 18 of each member through a communication network 16, such as the Internet. The game apparatus 14 communicates with the SNS server apparatus 12. The SNS server apparatus 12 also functions as a relay apparatus for relaying communications between the game apparatus 14 and each terminal apparatus 18.

The SNS server apparatus 12 is a web server for providing each member with an SNS, such as exchanging messages (email) between members. The game apparatus 14 is a web server for providing a member who owns a terminal apparatus 18 with an on-line game, such as a social game. Among the members of the SNS, a member who accesses the game apparatus 14 from the terminal apparatus 18 plays a desired game. In an actual case, a plurality of game apparatuses 14 providing different games are connected to the SNS server apparatus 12, and, among the plurality of game apparatuses 14, a game apparatus 14 having a game desired by a member provides the member with the game. For convenience, FIG. 1 shows just one game apparatus 14.

The terminal apparatus 18 is a communication terminal, such as a portable telephone, a personal digital assistant (PDA), or a personal computer, and includes a display unit 22 and an input unit 24. The display unit 22 (such as a liquid crystal display panel) displays various types of images, such as a game screen. The input unit 24 is used by the user to input an instruction to the terminal apparatus 18, and includes a plurality of manipulanda operated by the user, for example. A touch sensitive panel integrated with the display unit 22 for receiving a user operation, or a microphone used by the user to input sound to give an instruction to the terminal apparatus 18 can be employed as the input unit 24. Wireless communication is typically used between the terminal apparatus 18 and the communication network 16, but wired communication can also used between the terminal apparatus 18 and the communication network 16 when a desktop personal computer is used as the terminal apparatus 18, for example.

As shown in FIG. 1, the SNS server apparatus 12 includes a controller 32, a storage unit 34, and a communication unit 36. The controller 32 executes various types of processes to provide an SNS for each terminal apparatus 18. The communication unit 36 communicates with each terminal apparatus 18 through the communication network 16 and also communicates with the game apparatus 14. The storage unit 34 stores a program executed by the controller 32 and various types of data used by the controller 32.

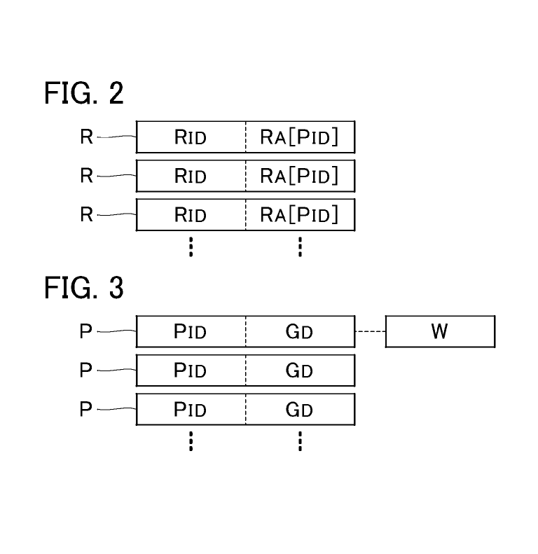

As shown in FIG. 2, the storage unit 34 stores, for each member, member information R related to the member. The member information R includes member identification information RID and played-game information RA, in addition to attribute information (not shown), such as the name and address of each member. The member identification information RID is a code given uniquely to each member when the member is registered. The played-game information RA specifies player identification information PID for a game that the member has actually played. The player identification information PID is a code given uniquely to each member when the member first plays the game.

As shown in FIG. 1, the game apparatus 14 includes a controller 42, a storage unit 44, and a communication unit 46. The controller 42 executes a program to provide a game for each terminal apparatus 18. The communication unit 46 communicates with the SNS server apparatus 12 and also communicates with each terminal apparatus 18 through the SNS server apparatus 12. The storage unit 44 stores the program executed by the controller 42 and various types of information used by the controller 42. The storage unit 44 may be installed in an external apparatus (such as a server) separated from the game apparatus 14, and the game apparatus 14 may acquire information from the storage unit 44 through the communication network 16. In other words, the storage unit 44 is not essential for the game apparatus 14. The storage unit 44 (one virtual storage unit) may be realized with a plurality of units configured separately from each other.

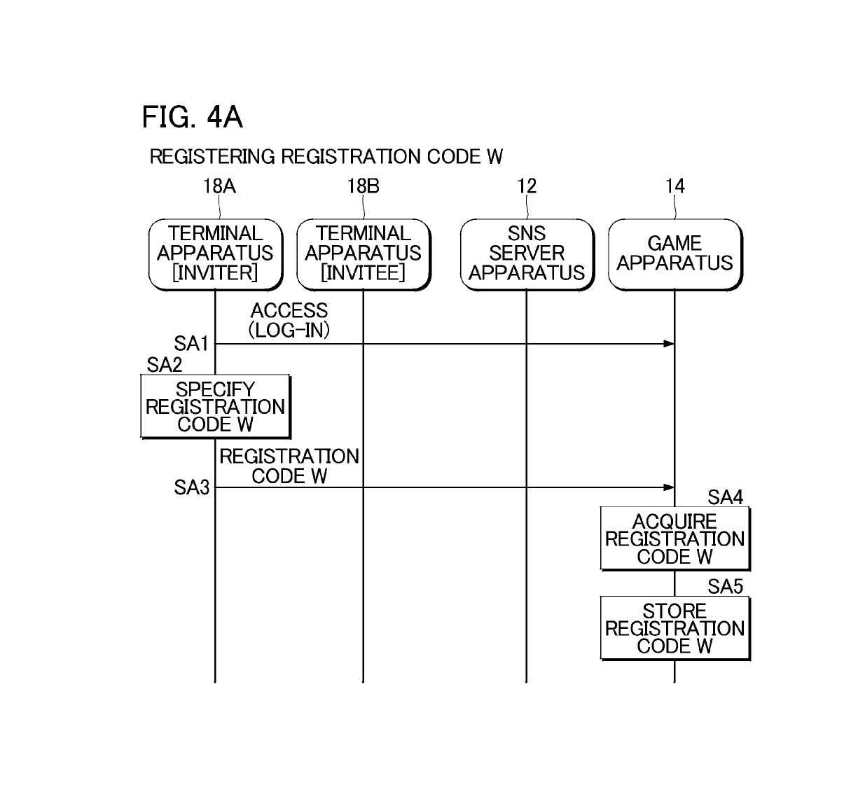

As shown in FIG. 3, the storage unit 44 stores player information P for each player. The player information P includes the player identification information PID and game data GD. The game data GD corresponds to the progress of the player in the game. For example, the game data GD specifies a parameter (such as health points) for the player, virtual currency acquired in an event in the game, or an item or a character used in an event in the game.

A player who has played a game can invite any member who has not yet played the game (hereafter called an invitee) to the game (in other words, can propose playing the game to an invitee). A player who invites the invitee to the game (hereafter may be called an inviter) needs to register a registration code W to the game apparatus 14 before inviting the invitee. The registration code W corresponds to a sign (password) shared between the inviter and the invitee. As shown in FIG. 3, the registration code W is associated with the player information P of the inviter who registered the registration code W and is stored. The inviter can register a desired registration code W any time before inviting the invitee.

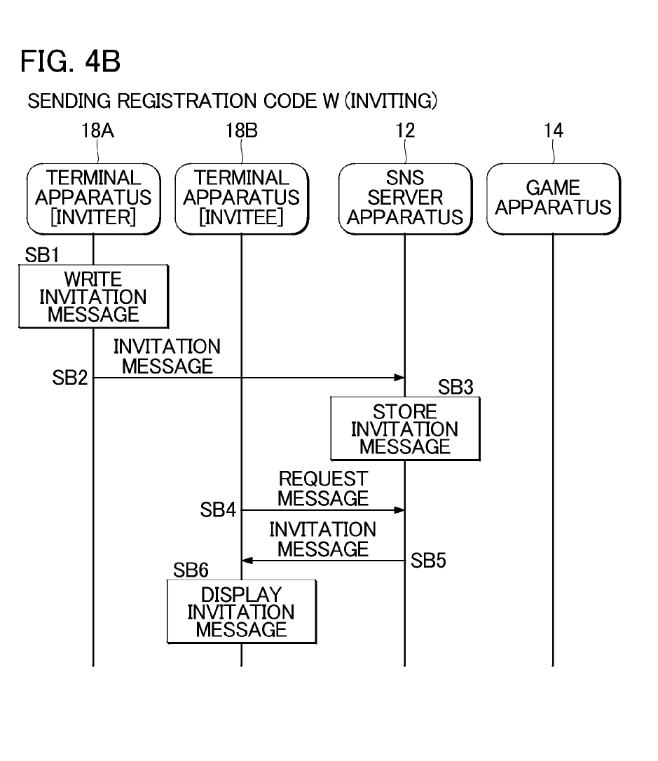

FIG. 4 is a flowchart of a procedure in which the inviter registers a registration code W. In the following description, the code assigned to the terminal apparatus 18 may be divided between a terminal apparatus 18A of the inviter and a terminal apparatus 18B of the invitee, for convenience.

While the terminal apparatus 18A of the inviter accesses the game apparatus 14 (step SA1), if the inviter operates the input unit 24 to specify a desired registration code W and to give an instruction to the terminal apparatus 18A to send the registration code W (step SA2), the registration code W specified by the inviter is sent from the terminal apparatus 18A to the game apparatus 14 through the SNS server apparatus 12 (step SA3). More specifically, a registration request that includes the registration code W and the member identification information RID of the inviter is sent from the terminal apparatus 18A to the SNS server apparatus 12. The controller 32 of the SNS server apparatus 12 refers to the member information R stored in the storage unit 34 to search for the player identification information PID of the inviter corresponding to the member identification information RID specified in the registration request, and sends a registration request that includes the player identification information PID and the registration code W to the game apparatus 14.

The controller 42 of the game apparatus 14 acquires the registration code W from the registration request received from the SNS server apparatus 12 (step SA4), and adds the registration code W to the player information P corresponding to the player identification information PID specified in the registration request, among a plurality of player information items P stored in the storage unit 44 (step SA5). In other words, the controller 42 functions as an element for acquiring the registration code W specified by the inviter from the terminal apparatus 18A of the inviter (registration-code acquisition section), and the storage unit 44 functions as an element for associating the registration code W specified by the inviter with the player identification information PID of the inviter and storing them (storage section). This is the procedure for registering the registration code W. To make a registration code W unique to each inviter, when the registration code W specified by the inviter has already been registered in the game apparatus 14, the game apparatus 14 can request the inviter to specify another registration code W.

When the inviter registers the registration code W in the above-described procedure, the inviter sends the registered registration code W to a desired invitee. In other words, the inviter invites the invitee to the game. For example, the inviter can use a message notification service (for example, an email service limited to the members) provided by the SNS server apparatus 12 to send the registration code W to the invitee. FIG. 4B is a flowchart of a procedure in which the inviter sends the registration code W to the invitee. The process shown in FIG. 4B is executed any time after the registration code W is registered.

The inviter operates the input unit 24 of the terminal apparatus 18A to write a message (hereafter called an invitation message) for which a desired invitee is specified as a destination (step SB1). The invitation message includes the name of the game to which the inviter invites the invitee and the registration code W registered by the inviter. The SNS server apparatus 12 receives the invitation message that the inviter sent from the terminal apparatus 18 (step SB2), and associates the invitation message with the member information R of the invitee specified as the destination by the inviter and stores them in the storage unit 34 (step SB3).

The invitee can use the terminal apparatus 18B to check, at any time, a message sent to him or her. When a request to check a message is made by the terminal apparatus 18B of the invitee (step SB4), the controller 32 of the SNS server apparatus 12 sends the invitation message associated with the member information R of the invitee to the terminal apparatus 18B of the invitee and causes the display unit 22 to display it (steps SB5 and SB6). The invitee checks the invitation message to find out the name of the game that he or she is invited to by the inviter and the registration code W.

A registered member can play the game any time by accessing the game apparatus 14 from the terminal apparatus 18. Once the invitee finds out the registration code W in the procedure described above, the invitee can send the registration code W acquired from the inviter to the game apparatus 14. FIG. 4C is a flowchart of a procedure in which the invitee sends the registration code W to the game apparatus 14. While the terminal apparatus 18B of the invitee accesses the game apparatus 14 providing the game specified in the invitation message (step SC1), the invitee operates the input unit 24 to specify the registration code W that he or she finds out (indicated by a verification code WC in the following description in order to differentiate it from the registration code W already registered) at the terminal apparatus 18B (step SC2). The invitee can specify the verification code WC any time after the game starts.

The verification code WC specified by the invitee is sent to the communication network 16 with the game apparatus 14 set as the destination (step SC3). The controller 42 of the game apparatus 14 acquires the verification code WC sent from the terminal apparatus 18B of the invitee, from the SNS server apparatus 12 (step SC4), and searches the storage unit 44 for the registration code W that matches the verification code WC (step SC5). In other words, the controller 42 functions as an element for acquiring the verification code WC from the terminal apparatus 18B of the invitee (verification-code acquisition section) and also functions as an element for searching the storage unit 44 for the registration code W that matches the verification code WC (code verification section). The invitee invited officially by the inviter knows the registration code W specified by the inviter, whereas a member not invited by the inviter does not know the registration code W specified by the inviter. Therefore, the verification in step SC5 corresponds to a process for determining whether the person who inputs the verification code WC is the invitee officially invited by the inviter.

When the registration code W that matches the verification code WC of the invitee is found (in other words, the person who inputted the verification code WC is found to be an official invitee), the controller 42 grants a game-related privilege to the player (inviter) indicated by the player identification information PID stored in the storage unit 44 and associated with the registration code W (step SC6). The privilege granted to the inviter is, for example, something that allows an advantage to be achieved in the game. For example, a specific item or a specific character is awarded, virtual currency in the game is awarded, or an increase in a parameter related to the player is awarded as a privilege to the inviter. In other words, the controller 42 updates the game data GD of the inviter so as to grant a privilege, such as that described above, to the inviter. The details of the privilege granted to the inviter are reported to him or her when he or she plays the game. As understood from the above description, the controller 42 functions as an element for granting a privilege in the game to the player (inviter) corresponding to the registration code W that matches the verification code WC (a privilege granting section). In contrast, when the storage unit 44 does not have a registration code W that matches the verification code WC of the invitee (in other words, when the person who inputted the verification code WC is not an official invitee, or when the invitee inputted a wrong verification code WC), the controller 42 causes the display unit 22 of the terminal apparatus 18B of the invitee to display the fact that the verification code WC is incorrect (not shown).

In the first embodiment described above, since the registration code W corresponding to the verification code WC specified by the invitee is searched for in the storage unit 44, which stores the registration code W shared between the inviter and the invitee and the player identification information PID of the inviter in association with each other, even if the invitee has never played the game and has not yet been assigned player identification information PID when the inviter invites the invitee, it is possible to grant a privilege to the inviter who has invited the invitee.

It may be also possible that the SNS server apparatus 12 uses the member identification information RID of each member to provide a service for inviting another member to the game. For example, the SNS server apparatus 12 associates the member identification information RID of a member who is an inviter with the member identification information RID of a member who is an invitee and grants a privilege to the member indicated by the member identification information RID of the inviter corresponding to the member identification information RID of the invitee when the invitee actually plays the game. In that case, however, the number of times each member can invite other members to the game may be restricted due to SNS operational circumstances, for example. In the first embodiment, irrespective of whether the invitation service of the SNS server apparatus 12 is restricted or not, the inviter can invite an invitee to the game. Therefore, it is possible to make the game provided by the game apparatus 14 more wide-spread.

In the first embodiment, since the inviter can specify a desired registration code W, when words that are easy to memorize for both the inviter and the invitee are specified as a registration code W, an advantage is provided in that it is possible to reduce cases where the invitee forgets the verification code WC or the invitee specifies a wrong verification code WC.

It may be also possible, as a method of granting a privilege to an inviter by managing the relationship between the inviter and an invitee, that the member identification information RID (or player identification information PID) of the inviter and the member identification information RID of the invitee are stored in the game apparatus 14 in association with each other, and when the invitee accesses the game apparatus 14, a privilege is granted to the inviter corresponding to the member identification information RID of the invitee (hereafter called a comparison case). When an inviter invites a plurality of invitees in the comparison case, however, it is necessary to store the member identification information RID of the invitees for the inviter in the storage unit 44, thus increasing the required capacity of the storage unit 44. In contrast, in the first embodiment, even if an inviter invites a plurality of invitees, if just one registration code W is stored for the inviter in the storage unit 44, a privilege is granted to the inviter every time the invitees input the verification code WC. In other words, since it is not necessary to store the member identification information RID of the invitees for the inviter, the required capacity of the storage unit 44 is lower than in the comparison case.

### Second Embodiment

A second embodiment of the present invention will be described below. In the second embodiment, the game apparatus 14 instructs the SNS server apparatus 12 to provide an invitation message to the invitee, whereas, in the first embodiment, the inviter sends an invitation message to the invitee by himself or herself. Note that, for units in the following example embodiments having the same effects or functions as in the first embodiment, the reference codes used in the above description will be used again, and detailed descriptions thereof will be omitted, if unnecessary.

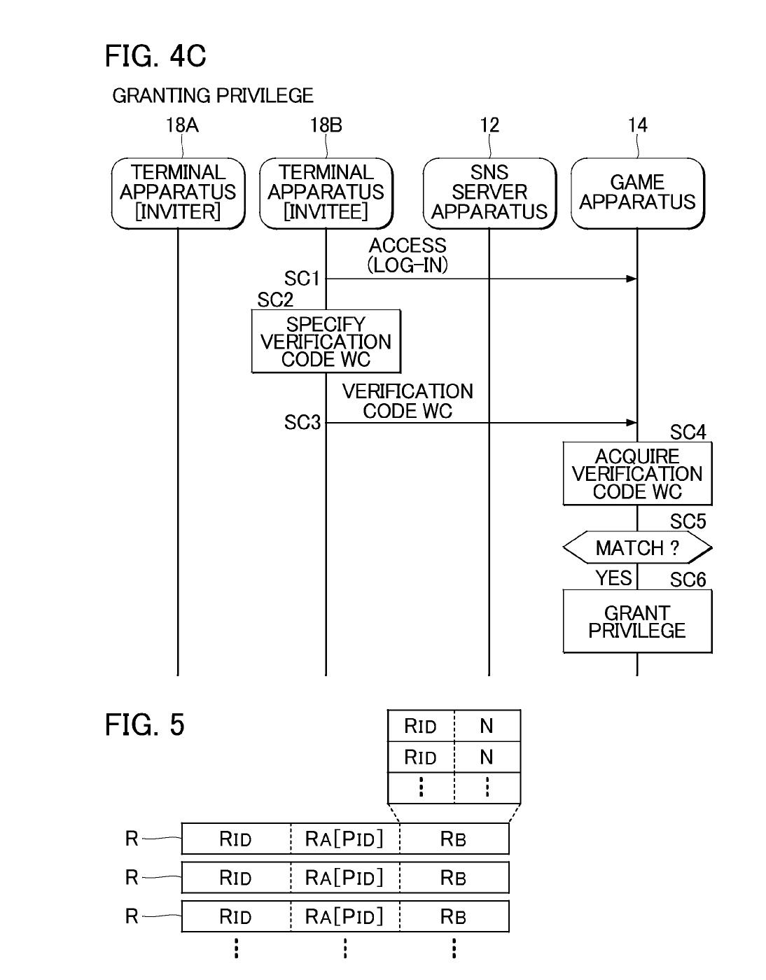

FIG. 5 is a typical view of member information R stored for each member in the storage unit 34 of the SNS server apparatus 12 in the second embodiment. As shown in FIG. 5, the member information R in the second embodiment includes member relationship information RB in addition to the same member identification information RID and the same played-game information RA as in the first embodiment. The member relationship information RB specifies the relationship (socialgraph) with other members. Specifically, the member relationship information RB of each member specifies the member name N and the member identification information RID of each other member for whom friendship or acquaintanceship with the member has been registered. The member name is the name or title of each member.

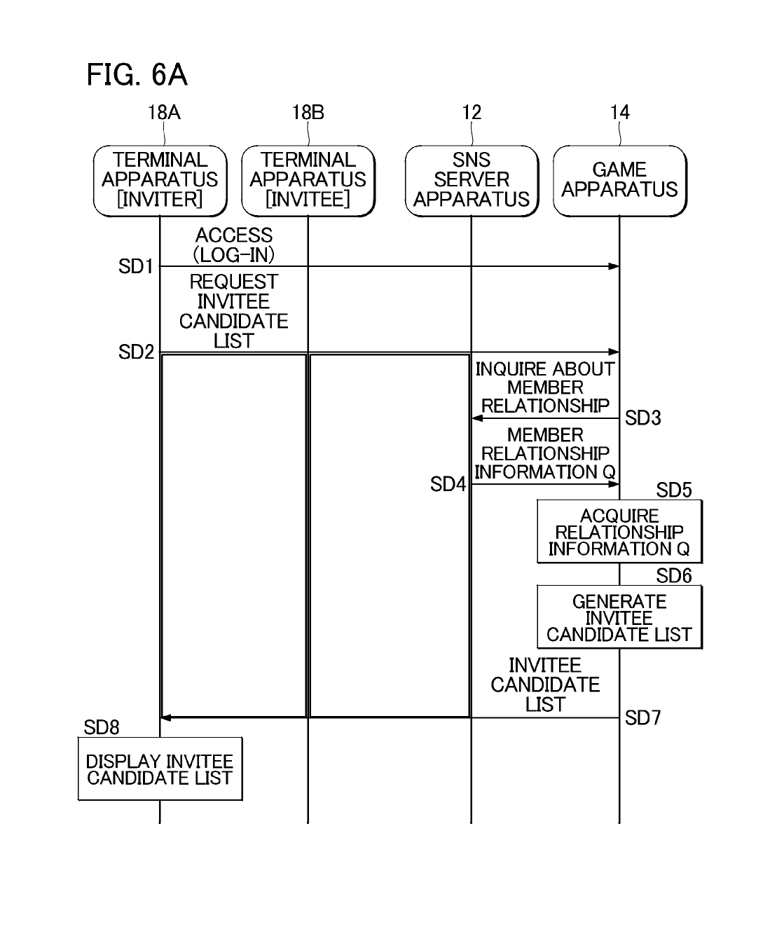

FIG. 6A and FIG. 6B form a flowchart of a procedure for providing an invitation email (sending the name of a game to which the invitation is made and a registration code W) to the invitee in the second embodiment. The processing shown in FIG. 6A and FIG. 6B is executed any time after the inviter registers a registration code W. While the terminal apparatus 18A of the inviter accesses the game apparatus 14 (step SD1), when the inviter applies a predetermined operation to his or her own terminal apparatus 18A, the terminal apparatus 18A sends a request for a list of invitee candidates (hereafter called an invitee candidate list) to the game apparatus 14 through the SNS server apparatus 12 (step SD2). The request for the invitee candidate list includes the member identification information RID of the inviter, and is sent to the game apparatus 14 after the member identification information RID is changed to the corresponding player identification information PID in the SNS server apparatus 12.

Upon receiving the request for the invitee candidate list, the controller 42 of the game apparatus 14 sends a request (hereafter called a member relationship inquiry) for the member relationship information Q of the inviter indicated by the player identification information PID included in the request for the invitee candidate list to the SNS server apparatus 12 (step SD3). The member relationship inquiry (for example, an API call) specifies the player identification information PID included in the request for the invitee candidate list. Upon receiving the member relationship inquiry, the controller 32 of the SNS server apparatus 12 searches the storage unit 34 for the member information R of the member indicated by the player identification information PID specified by the member relationship inquiry (that is, the inviter, who is the sender of the request for the invitee candidate list), generates the member relationship information Q formed of the member relationship information RB of the member information R and the played-game information RA of the members specified by the member relationship information RB (that is, friends or acquaintances of the inviter), and sends the member relationship information Q to the game apparatus (step SD4). The member relationship information Q specifies the member name N and the member identification information RID of each of members who have friendship or acquaintanceship with the inviter, and whether they have played the game, indicated by their played-game information RA.

The controller 42 of the game apparatus 14 acquires the member relationship information Q sent from the SNS server apparatus 12 (step SD5). In other words, the controller 42 functions as an element (relationship acquisition section) for acquiring the member relationship information Q, which specifies the members for whom the relationship with the inviter has been registered (and whether they played the game) from the SNS server apparatus 12.

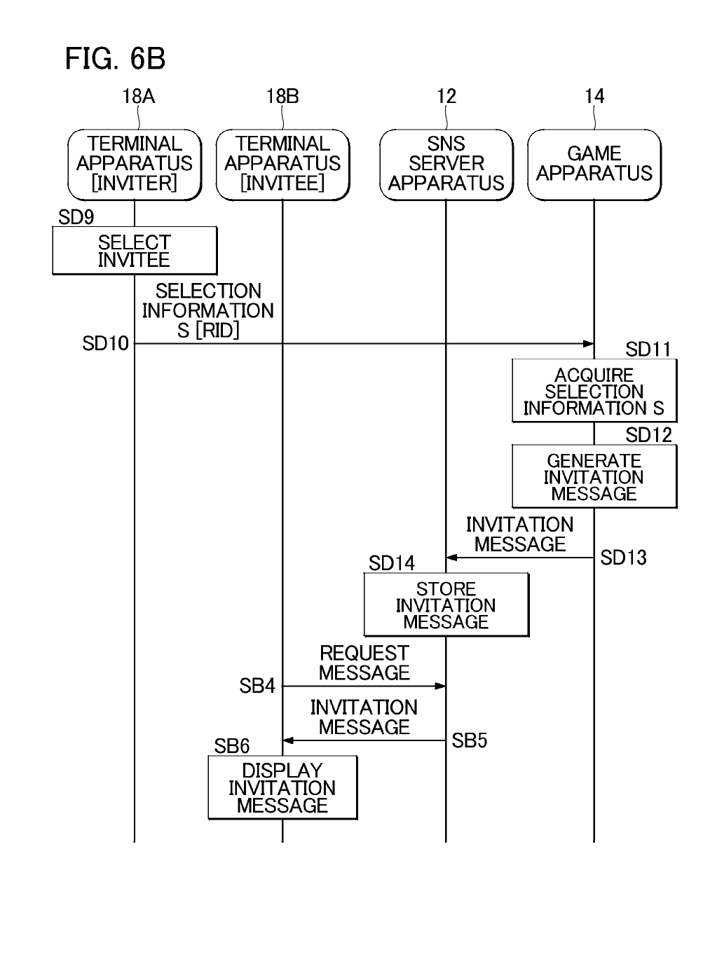

The controller 42 generates an invitee candidate list L in which members who have friendship or acquaintanceship with the inviter are listed as invitee candidates, according to the member relationship information Q acquired in step SD5 (step SD6). As shown in FIG. 7, the invitee candidate list L is a table listing the member name N, the member identification information RID, and whether the member has played the game, for each of the members (that is, friends and acquaintances of the inviter) indicated by the member relationship information Q. The controller 42 sends the invitee candidate list L generated in step SD6 to the terminal apparatus 18A of the inviter and causes the display unit 22 to display the invitee candidate list L (steps SD7 and SD8).

The inviter can appropriately operate the input unit 24 of the terminal apparatus 18A to select, as an invitee, a desired member from the invitee candidate list L in which the member identification information RID and the member names N are listed (step SD9). The inviter checks, in the invitee candidate list L, whether each member has played the game, and then, selects, as an invitee, a member who has not yet played the game among the plurality of members listed in the invitee candidate list L. In the invitee candidate list L, it is possible to disable the selection of a member who has played the game. As understood from the above description, the controller 42 of the game apparatus 14 functions as an element for providing the terminal apparatus 18A of the inviter with the members specified by the member relationship information Q as invitee candidates (candidate providing section).

When the inviter operates the input unit 24 to select an invitee, the terminal apparatus 18A sends selection information S that specifies the member identification information RID of the invitee selected by the inviter from the invitee candidate list L (step SD10). The controller 42 of the game apparatus 14 acquires, from the SNS server apparatus 12, the selection information S sent from the terminal apparatus 18A (step SD11). In other words, the controller 42 functions as an element for acquiring the selection information S, which specifies the member selected by the inviter as an invitee (that is, a selection accepting section for accepting the selection of an invitee performed by the inviter).

When acquiring the selection information S in the above procedure, the controller 42 generates an invitation message (step SD12). The invitation message includes the registration code W of the inviter, stored in the storage unit 44, and the name of the game to which the inviter invites the invitee (for example, the text “You are invited to game “a” by person “A”. The password is “XXX”). The controller 42 instructs the SNS server apparatus 12 to provide the invitation message to the member identification information RID (invitee) specified by the selection information S acquired in step SD11 (step SD13). In other words, the controller 42 functions as an element for instructing the SNS server apparatus 12 to provide an invitation message that includes the registration code W registered by the inviter, to a member specified by the inviter as an invitee (that is, a code notification section for notifying the invitee of the registration code W registered by the inviter).

The SNS server apparatus 12 receives the invitation message from the game apparatus 14, and stores the invitation message and the member information R (that is, the member information R of the invitee) corresponding to the member identification information RID specified as the destination of the invitation message among a plurality of member information R stored in the storage unit 34, in association with each other (step SD14). The invitee checks the invitation message sent to him or her in the same procedure as in the first embodiment (steps SB4 to SB6) to find out the name of the game to which the inviter invites him or her and the registration code W registered by the inviter. A process for the invitee to input a verification code WC, a process for granting a privilege to the inviter, and other processes are the same as those in the first embodiment.

The second embodiment also achieves the same advantages as the first embodiment. In the second embodiment, since the game apparatus 14 instructs the SNS server apparatus 12 to provide a message notifying the invitee of the registration code W, it is not necessary for the inviter to notify the invitee of the registration code W. Therefore, the load imposed on the inviter can be reduced.

In the second embodiment, since members registered as having relationships (friendships or acquaintanceships) with the inviter are provided as invitee candidates for the terminal apparatus 18A of the inviter in a selectable manner, the load imposed on the inviter to select a desired invitee can be reduced (for example, the inviter can easily invite another member having friendship or acquaintanceship as an invitee) compared with a case when the inviter selects an invitee from a large number of unspecified general members. In addition, in the second embodiment, since the invitee candidate list L indicates whether each member serving as an invitee candidate has played the game or not, the inviter can easily understand which members have not yet played the game.

### Third Embodiment

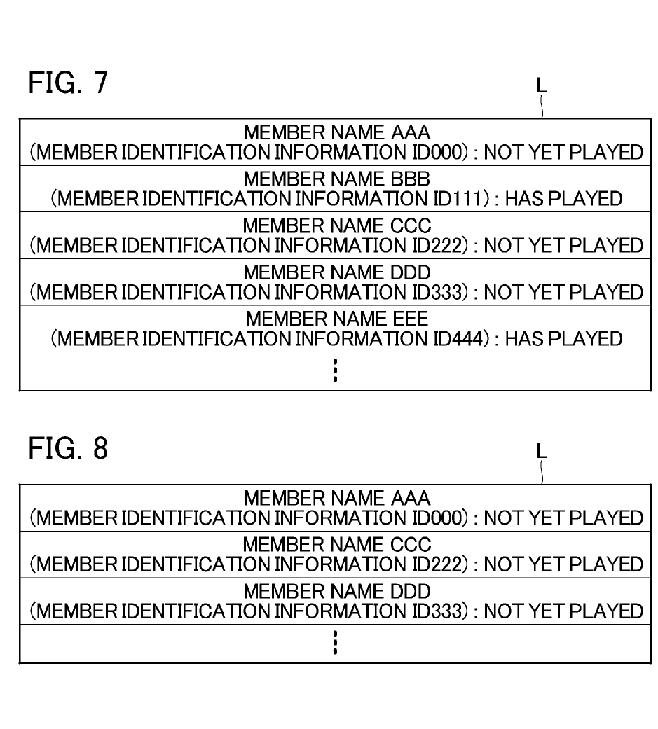

FIG. 8 is a typical view of an invitee candidate list L in a third embodiment of the present invention. In the invitee candidate list L in the third embodiment, members who have not yet played the game are selectively listed as invitee candidates among members having friendship or acquaintanceship with the inviter (that is, members specified by the member relationship information Q), as shown in FIG. 8, whereas, in the invitee candidate list L in the second embodiment (FIG. 7), it is indicated, for each member, whether the member has played the game or not. In other words, members who have already played the game are not included in the invitee candidate list L even though they have friendship or acquaintanceship with the inviter.

For example, among the members in the invitee candidate list L shown in FIG. 7 in the second embodiment, since the members having the member names BBB and EEE have already played the game, they are not included in the invitee candidate list L shown in FIG. 8. As understood from the above description, in the third embodiment, the controller 42 of the game apparatus 14 functions as an element for selectively providing the terminal apparatus 18A of the inviter with members who have not yet played the game, as invitee candidates, among the members specified by the member relationship information Q (candidate providing section). Everything other than the contents of the invitee candidate list L is the same as in the second embodiment.

The third embodiment also achieves the same advantages as the first embodiment. The third embodiment achieves a much better advantage than the second embodiment in that the inviter can easily select a member who has not yet played the game as an invitee because members who have not yet played the game are selectively provided as invitee candidates for the inviter among the members for whom the relationship (friendship or acquaintanceship) with the inviter has been registered.

### Fourth Embodiment

In the above-described embodiments, a privilege is granted to the inviter when the verification code WC input by the invitee matches the registration code W specified by the inviter. In that configuration, however, when the verification code WC differs from the registration code W specified by the inviter due to an erroneous input by the invitee or for some other reason, if that verification code WC accidentally matches a registration code W already registered by another player, a privilege would be granted to that player even though that player is not the inviter. Taking this situation into consideration, the invitee is asked to check an inviter to whom a privilege is to be granted, after the invitee inputs the verification code WC in the fourth embodiment.

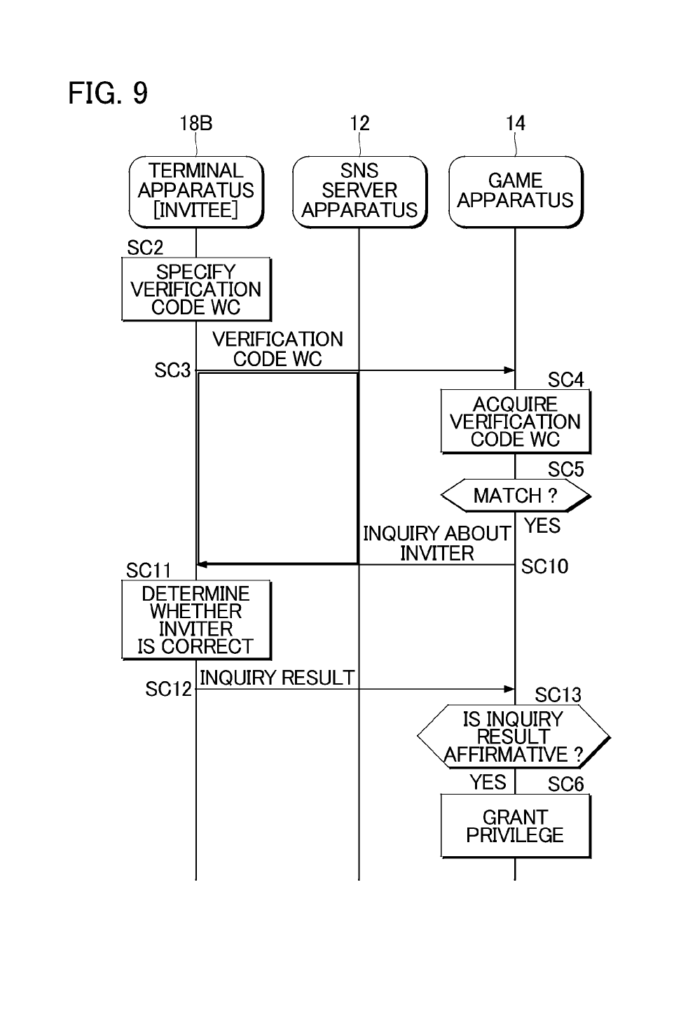

FIG. 9 is a flowchart of a procedure in which the verification code WC input by the invitee is compared with the registration code W and a privilege is granted to the inviter. In the same manner as in the first embodiment, the controller 42 of the game apparatus 14 acquires, from the SNS server apparatus 12, the verification code WC sent from the terminal apparatus 18B of the invitee (steps SC2 to SC4), and searches the storage unit 44 for the registration code W that matches the verification code WC (step SC5).

When the registration code W that matches the verification code WC is found, the controller 42 provides the terminal apparatus 18B of the invitee with the inviter indicated by the player identification information PID stored in the storage unit 44 in correspondence with the registration code W to ask the invitee whether the inviter is correct (step SC10). More specifically, the controller 42 causes the terminal apparatus 18B of the invitee to display the member identification information RID and the member name N managed by the SNS server apparatus 12, of the member indicated by the player identification information PID corresponding to the registration code W.

The invitee checks the member identification information RID and the member name N of the inviter, displayed on the terminal apparatus 18B, and operates the input unit 24 to determine whether those items indicate the inviter who has invited him or her (whether the inviter is correct) (step SC11). The inquiry result input by the invitee is sent to the game apparatus 14 through the SNS server apparatus 12 (step SC12). The controller 42 of the game apparatus 14 determines whether the inquiry result is affirmative (step SC13), and if the inquiry result is affirmative (if the inquiry-target member is the inviter), grants a privilege to the inviter (step SC6). If the inquiry result is negative (if the inquiry-target member is not the inviter), the controller 42 shows on the terminal apparatus 18B of the invitee that the verification code WC is incorrect and does not grant a privilege (does not execute the process of step SC6). As understood from the above description, the controller 42 in the fourth embodiment functions as an element for asking the invitee whether the inviter corresponding to the registration code W found from the verification code WC is correct (inviter inquiry section), and also as an element for granting a privilege to the inviter when the inquiry result input by the invitee is affirmative (privilege granting section).

The fourth embodiment also achieves the same advantages as the first embodiment. In the fourth embodiment, when the invitee determines that the inviter corresponding to the registration code W found from the verification code WC is correct, a privilege is granted to the inviter. Therefore, even if the registration code W that matched a wrongly input verification code WC is stored in the storage unit 44, a privilege is prevented from being granted to the player corresponding to that registration code W (to a person who is not the inviter, to whom a privilege should be granted). When a plurality of inviters use the same registration code W, the invitee is asked to determine the inviter who actually invited him or her among the plurality of inviters who used the same registration code W, so that it is possible to determine the person to which a privilege should be granted. The configuration of the fourth embodiment in which it is queried whether the inviter is correct can also be applied to the second and third embodiments in the same manner.

### Modifications

The embodiments described above can be modified in various ways. Specific example modifications will be described below. Two or more of the following modifications selected in a desired manner can be appropriately combined in a range in which no mutual contradiction occurs.

(1) In the embodiments described above, the message notification service provided by the SNS server apparatus 12 is used to notify the invitee of the registration code W. Any method can be used to notify the invitee of the registration code W. For example, it is possible for the inviter to use an electronic mail or a telephone to notify the invitee of the registration code W.

(2) In the second embodiment, the invitee candidate list L shows, for each member having friendship or acquaintanceship with the inviter, whether he or she has played the game. It is possible to omit the configuration for notifying the inviter whether members having friendship or acquaintanceship with the inviter have played the game. For example, it is possible that the SNS server apparatus 12 sends the member relationship information RB stored therein to the game apparatus 14 as the member relationship information Q (step SD4) and all members specified by the member relationship information Q are included in the invitee candidate list L without differentiating them by whether they have played the game.

(3) In the embodiments described above, the inviter specifies the registration code W in a desired manner. The controller 42 of the game apparatus 14 may specify the registration code W. In that case, for example, when the terminal apparatus 18A of the inviter gives an instruction to register a registration code W, the controller 42 automatically specifies a registration code W so as to be unique among inviters and notifies the inviter of the specified registration code W.

(4) In the embodiments described above, a privilege is granted to the inviter (step SC6). When the verification code WC matches the registration code W, privileges can be granted to both the inviter and the invitee.

(5) In the embodiments described above, the SNS server apparatus 12 relays communications between the game apparatus 14 and each terminal apparatus 18. It is also possible that the game apparatus 14 communicates with each terminal apparatus 18 without using the SNS server apparatus 12. The functions of the SNS server apparatus 12 can be included in the game apparatus 14. The SNS server apparatus 12 can be omitted.

### DESCRIPTION OF REFERENCE NUMERALS

100: Communication system
12: SNS server apparatus
14: Game apparatus
16: Communication network
18: Terminal apparatus
22: Display unit
24: Input unit
32: Controller
34: Storage unit
36: Communication unit
42: Controller
44: Storage unit
46: Communication unit

1. A game apparatus for providing a game while communicating with individual terminal apparatuses, the game apparatus comprising:
a verification-code acquisition section that acquires a verification code from a terminal apparatus of an invitee who is invited to the game by a player of the game who serves as an inviter;
a code verification section that searches a storage section that stores identification information of each player of the game and a registration code specified for the player in association with each other, for a registration code that matches the verification code acquired by the verification-code acquisition section; and
a privilege granting section that grants a privilege related to the game to an inviter indicated by the identification information stored in the storage section in association with the registration code searched for by the code verification section.

2. The game apparatus according to claim 1, wherein the storage section stores a registration code specified by an inviter and identification information of the inviter in association with each other.

3. The game apparatus according to claim 1, further comprising:
a selection accepting section that acquires selection information that specifies an invitee selected by the inviter; and
a code notification section that notifies the invitee specified by the selection information acquired by the selection accepting section, of the registration code specified by the inviter.

4. The game apparatus according to claim 3, further comprising:
a relationship acquisition section that acquires member relationship information that specifies a member for whom a relationship with the inviter has been registered; and
a candidate providing section that provides a terminal apparatus of the inviter with the member specified by the member relationship information acquired by the relationship acquisition section as an invitee candidate;
wherein the selection information specifies a member selected by the inviter from the member provided by the candidate providing section.

5. The game apparatus according to claim 4, wherein the member relationship information indicates, for each member specified by the member relationship information, whether the member has played the game; and
the candidate providing section provides the terminal apparatus of the inviter with information indicating whether the member has played the game, for each member specified by the member relationship information.

6. The game apparatus according to claim 4, wherein the member relationship information indicates, for each member specified by the member relationship information, whether the member has played the game; and
the candidate providing section provides the terminal apparatus of the inviter with a member who has not yet played the game from a member specified by the member relationship information.

7. The game apparatus according to claim 1, further comprising an inviter inquiry section that provides the terminal apparatus of the invitee with the inviter indicated by the identification information stored in the storage section in association with the registration code searched for by the code verification section and asks the invitee whether the inviter is correct;
wherein, when the result of the inquiry made by the inviter inquiry section is affirmative, the privilege granting section grants the privilege to the inviter.

8. A program for causing a computer that provides a game while communicating with individual terminal apparatuses to function as:
a verification-code acquisition section that acquires a verification code from a terminal apparatus of an invitee who is invited to the game by a player of the game who serves as an inviter;
a code verification section that searches a storage section that stores identification information of each player of the game and a registration code specified for the player in association with each other, for a registration code that matches the verification code acquired by the verification-code acquisition section; and
a privilege granting section that grants a privilege related to the game to an inviter indicated by the identification information stored in the storage section in association with the registration code searched for by the code verification section.

9. A game providing method of providing a game while communicating with individual terminal apparatuses, the game providing method comprising:
acquiring a verification code from a terminal apparatus of an invitee who is invited to the game by a player of the game who serves as an inviter;
searching a storage section that stores identification information of each player of the game and a registration code specified for the player in association with each other, for a registration code that matches the acquired verification code; and
granting a privilege related to the game to an inviter indicated by the identification information stored in the storage section in association with the registration code searched for.
